(19) United States
(12) Patent Application Publication
(10) Pub. No.: US 2010/0095251 A1
(43) Pub. Date: Apr. 15, 2010

(54) LINKAGE BETWEEN MOTION SENSING AND POSITION APPLICATIONS IN A PORTABLE COMMUNICATION DEVICE

(75) Inventor: Gregory A. Dunko, Cary, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB, Lund (SE)

(21) Appl. No.: 12/252,091

(22) Filed: Oct. 15, 2008

(51) Int. Cl. G06F 3/01

(52) U.S. Cl. 715/863

(57) ABSTRACT

Criteria for movement of a mobile communication device that can be initiated by the user are defined. A criterion can be stored as a data characteristic in device memory. Motion of the device can be sensed to determine, by the device controller, whether sensed motion meets the defined criterion. The sensed motion may be derived from an accelerometer, or equivalent means, in the device. If the sensed motion is determined by the controller to match stored criterion data, the controller triggers activation of an application that is dependent on location of the device. A stored application associated with the matched data characteristic is accessed from one or more stored applications respectively associated in memory with stored data characteristics.

### BACKGROUND

The present disclosure is related to mobile communications devices, more particularly to activation of device applications in accordance with sensed motion.

Mobile communication devices, such as cellular phones, laptop computers, pagers, personal communication systems (PCS), personal digital assistants (PDA), and the like, provide advantages of ubiquitous communication without geographic or time constraints, as well as the added security of being able to contact help in the event of an emergency. Device displays allow users to view and interact with a wide variety of applications, such as contact lists, calendar planners, mapping software, etc.

Advances in technology and services have also given rise to a host of “additional” features beyond merely voice communication including, for example, short or multimedia messaging, multimedia playback, electronic mail, audio-video capturing, interactive gaming, data manipulation, web browsing, and the like. Other enhancements, such as, location-awareness features, e.g., global position system (GPS) tracking, enable mobile communication devices to monitor their position and display their location. The ability of the mobile device to determine its position has spawned development of a variety of location based services and applications. Examples of such applications included turn-by-turn navigation display and instruction capability, user search capability to identify objects or establishments of interest in the location vicinity, and the ability to communicate automatically the location of the device to a remote recipient for updating the stored location of the mobile device. Development of additional such applications is ongoing.

Typically, user interaction with mobile device applications involves use of a keypad and/or touchscreen. However, such interaction can be cumbersome and non-intuitive when numerous different buttons are required to perform simple manipulations of displayed information. When a plurality of functions and applications are concurrently active, it may become necessary to toggle among various application options. As more sophisticated and complex applications become available, a greater burden is imposed on user interactivity.

A need thus exists for a more efficient and user friendly way to activate and use mobile device applications.

### SUMMARY OF DISCLOSURE

The above described needs are fulfilled, at least in part, by defining criteria for movement of a mobile communication device that can be initiated by the user. A criterion can be stored as a data characteristic in device memory. Motion of the device can be sensed to determine, by the device controller, whether sensed motion meets the defined criterion. The sensed motion may be derived from an accelerometer, or equivalent means, in the device.

If the sensed motion is determined by the controller to match stored criterion data, the controller triggers activation of an application that is dependent on location of the device. A stored application associated with the matched data characteristic is accessed from one or more stored applications respectively associated in memory with stored data characteristics.

Various movement criteria can be defined for association with a plurality of respective applications. A criterion can relate to a multi-directional change of position of the device. A criterion can relate to a change of orientation of the device. A criterion can be defined by a predetermined orientation pattern change.

Sensed motion that matches one criterion may trigger activation, for example from a standby state, of an electronic subsystem used for position determination of the communication device. Another criterion match may trigger updating a stored position of the device in the device memory, which may be accessible by a remote recipient. Such application may also be activated by the trigger to initiate transmission of a message that includes the updated position. Another movement criterion may be set to trigger activation of a navigation application stored in the communication device. A plurality of criteria may be sensed concurrently to activate related applications. For example, in addition to the navigation application, an application can be activated to launch a search process for locating points of interest to the user that are in a geographic area of the device location.

Still other aspects, features, and advantages will be readily apparent to those skilled in this art from the following detailed description, wherein preferred embodiments are shown and described, simply by way of illustration of the best mode contemplated. The disclosed concepts are capable of other and different embodiments, with details that are capable of modifications in various obvious respects. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1 is a block diagram of an exemplary mobile communication device;

FIG. 2 is a schematic illustration of structure of the mobile communication device of FIG. 1, exemplified as a mobile telephone;

FIG. 3 is a table representing a database accessed during operation of the mobile telephone of FIG. 2;

FIG. 4 is a flow chart of operation of one preferred embodiment; and

FIG. 5 is a flow chart of operation of another preferred embodiment.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with equivalent arrangements. In other instances, well-known structures and devices are shown in block diagram form in order to avoid unnecessarily obscuring exemplary embodiments.

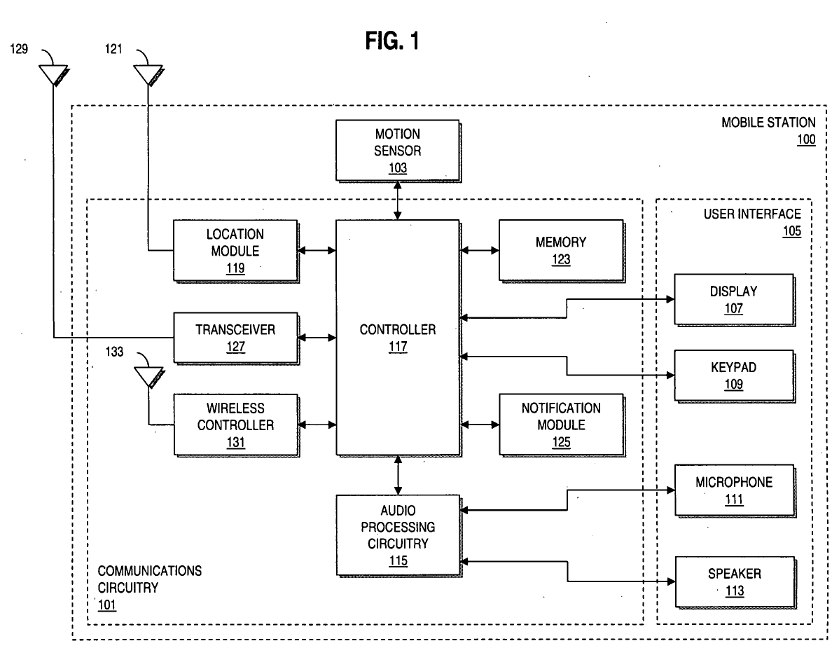

FIG. 1 is a block diagram of an exemplary mobile communication device 100, such as a cellular phone, laptop computer, or the like. Mobile station 100 includes communications circuitry 101, motion sensor 103, and user interface 105. User interface 105 includes display 107, keypad 109, microphone 111, and speaker 113. Display 107 provides a graphical interface that permits a user of mobile station 100 to view dialed digits, call status, menu options, and other service information. The graphical interface may include icons and menus, as well as other text and symbols. Keypad 109 includes an alphanumeric keypad and may represent other input controls, such as a joystick, button controls, touch panel, dials, etc. The user thus can construct user profiles, enter commands, initialize applications, input remote addresses, and select options from menu systems. Microphone 111 converts spoken utterances of a user into electronic audio signals, while speaker 113 converts electronic audio signals into audible sounds.

Communications circuitry 101 includes audio processing circuitry 115, controller 117, location module 119 (such as GPS receiver) coupled to antenna 121, memory 123, notification module 125, transceiver 127 coupled to antenna 129, and wireless controller 131 couple to antenna 133. Memory 123 may represent a hierarchy of memory, which may include both random access memory (RAM) and read-only memory (ROM). Computer program instructions that correspond to various device applications, including location based applications, and corresponding data for application operation can be stored in non-volatile memory, such as erasable programmable read-only memory (EPROM), electrically erasable programmable read-only memory (EEPROM), and/or flash memory. Memory 123 may be implemented as one or more discrete devices, stacked devices, or integrated with controller 117. Memory 123 may store information, such as one or more user profiles, one or more user defined policies, one or more contact lists, etc.

Controller 117 controls the operation of mobile station 100 according to programs and/or data stored to memory 123. Control functions may be implemented in a single controller or via multiple controllers. Suitable controllers may include, for example, both general purpose and special purpose controllers and digital signal processors. Controller 117 may interface with audio processing circuitry 115, which provides basic analog output signals to speaker 113 and receives analog audio inputs from microphone 111.

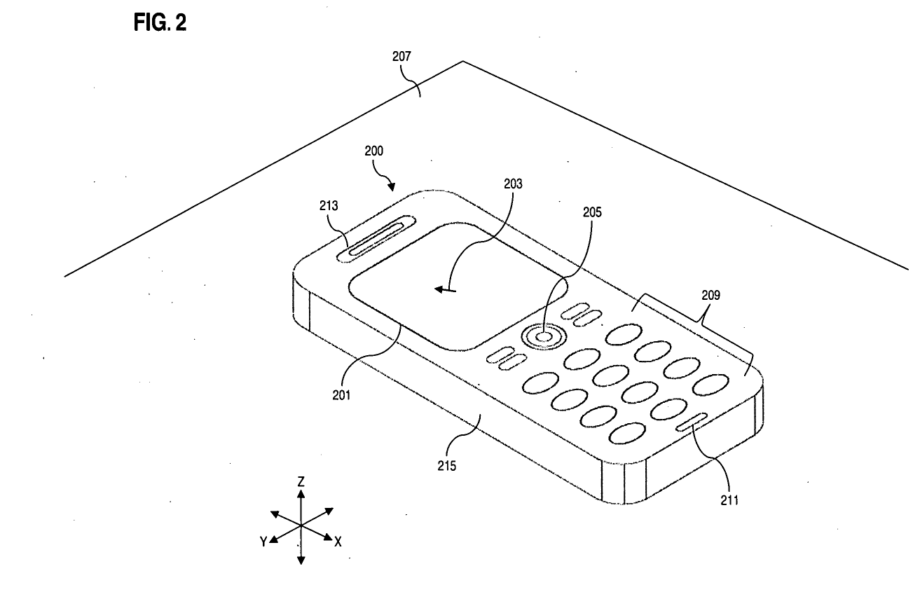

FIG. 2 is a schematic diagram of an exemplary mobile phone equipped as described above with respect to FIG. 1. Mobile phone 200 is embodied in a housing 215, a surface of which includes display 201, shown with cursor 203 as an exemplified image. Also illustrated are user inputs, such as standard number keys 209, and other user inputs such as key mechanism 205. Movement of the cursor may be controlled in response to user manipulation of the input keys. Microphone 211 and speaker 213 are also located on the housing surface. Although the mobile phone housing 215 is illustrated as in a brick-like (or candy bar) structural model, the present disclosure is applicable to alternative phone structural housings, such as a foldable (or clamshell) housing, slide housing, swivel housing, and the like.

Motion sensor 103 outputs to the controller electrical signals that correspond to movement of the mobile station. The controller can process these signals to determine, for example, a three-dimensional path of travel, a change in orientation of the phone structure or a pattern of movement. Although an accelerometer is contemplated for generating sensed motion signals, an equivalent device such as a gyroscope, a magnetometer, or any type of Micro Electro-Mechanical Systems (MEMS) may be employed as the motion sensor 103.

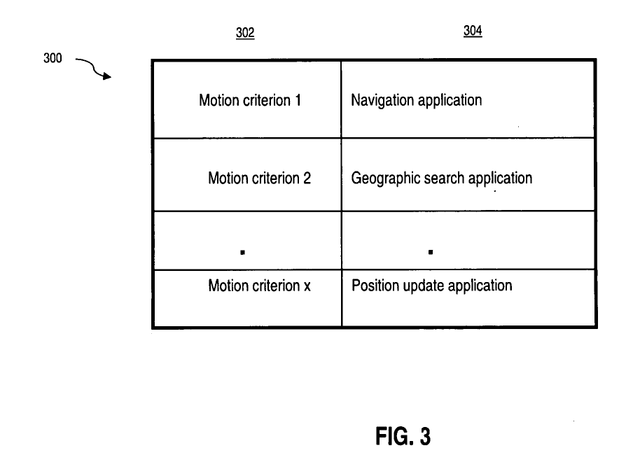

A particular spatial movement of the device can be adopted to define a criterion against which user initiated movement can be compared by the controller. In a database stored in memory 123 the criterion is linked with a specified location dependent device application that is stored in memory. The database may contain a plurality of links between criteria and respective location dependent device applications, as illustrated in FIG. 3. Database 300 is represented by a table including a plurality of different criteria 302 that are linked to respective location dependent applications 304. Each criterion is represented in memory by data that defines a unique spatial movement of the mobile device. In the illustrated example, a first criterion is linked to a navigation application, a second criterion is linked to a geographic search application, and another criterion is linked to a position update application.

In reference again to FIG. 2, in operation, a user may displace or move mobile phone 201 along or about surface 207, e.g., in an imaginary X-direction, an imaginary Y-direction, or combinations thereof, or about an axis of rotation extending in an imaginary Z-direction. A criterion may correspond to movement in any of the three-dimensional X-Y-Z directions and any combination thereof, to any specific motion pattern, and/or to any device orientation change or pattern of change. Orientation change may include, for example, changes in tilt, turn, roll, pitch, yaw, etc. Thus, the manner in which the phone is moved by the user will trigger activation of one or more of the stored location based applications. For instance, the user may select an application by moving the phone in a predetermined circular fashion. Such movement is monitored by the motion sensor and matched by the controller to the corresponding application in the database to activate the selected location based application.

As noted previously, there exist a variety of location based applications that are available for mobile device operation. While mobile station 100 may be equipped with a position determination capability, such as GPS, such capability may be mobile based, network based, or a combination of mobile and network based capabilities.

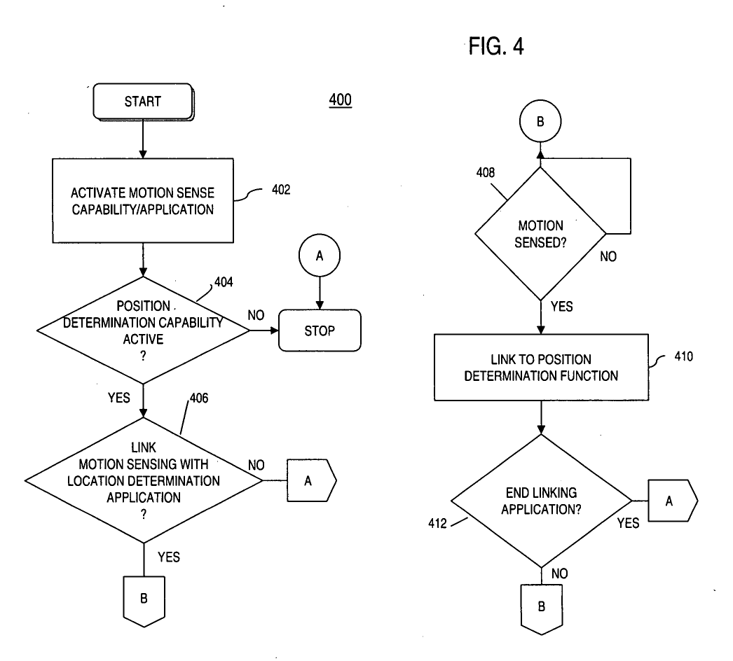

FIG. 4 is a flow chart 400 for operation of one system embodiment, wherein location based mobile device applications are triggered in response to sensed motion. In this embodiment, the sensed motion data criteria define a path of movement of the device in any of the three dimensions or a path pattern. The mobile device is initially equipped with motion sensing capability and position determination capability. Motion sensing may be performed by an accelerometer coupled with the device controller. Position determination may be performed by the mobile based GPS system or in combination with a network platform. Operation linking sensed motion of the mobile device with a location based application stored in the device is performed in accordance with a linking application. Such operation can occur after the linking application is launched and the sensing capability and the position determination capability are active.

At block 402, an application governing the motion sensing capability of the mobile device is activated. Determination is made at block 404 of whether the position determination capability, e.g., GPS, is active in a standby operational mode. The standby mode may be set as a start up default or thereafter by user input. If it is determined at block 404 that position determination capability is not active, the process terminates. If position determination capability is active, as determined at block 404, determination is made at block 406 as to whether the linking application is active. The linking application may be launched in response to user action, e.g. key entry, or may occur automatically, such as by a default start up setting. If the linking application is not active, the process terminates.

If the linking application is active, as determined at block 406, determination is made at block 408 whether motion is sensed and, if so, whether the sensed motion matches a criterion. This determination is made by the controller by comparing data represented by signals output by the motion sensor with the stored data characteristics of each stored data criterion. If no motion is sensed that matches a stored criterion, the process continues at block 408 until a motion is sensed. If motion is sensed that matches a criterion at block 408, the controller links the matched criterion to, and activates, the corresponding location database application at block 410. The linking, for example, may launch an application to activate position determination electronics, launch a position determination application, determine a position of the device and/or use the position in another application.

After activation at block 410, determination is made at block 412 whether the linking application is to be deactivated. Deactivation may responsive to a user input. If the link application is to remain active, as determined in block 412, the process reverts to block 408 to await further motion sensing; otherwise the process terminates.

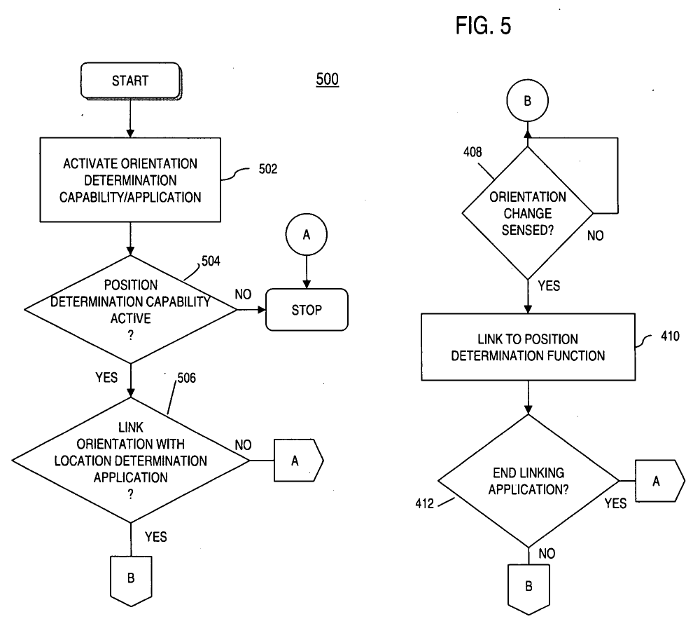

FIG. 5 is a flow chart 400 for operation of another system embodiment, wherein location based mobile device applications are triggered in response to change of the device orientation. A default orientation may be established for the mobile device, for example, in the position shown in FIG. 2. An orientation change criterion may correspond to a rotation of the device by a prescribed amount by any of the X-Y-Z axes or combinations thereof. The mobile device is initially equipped with motion sensing capability and position determination capability. Orientation change may be determined in response to motion sensed by an accelerometer or equivalent device coupled with the device controller. Position determination may be performed by the mobile based GPS system or in combination with a network platform. Operation linking sensed orientation change of the mobile device with a location based application stored in the device is performed in accordance with a linking application. Such operation can occur after the linking application is launched and the sensing capability and the position determination capability are active.

At block 502, an application governing orientation sensing capability of the mobile device is activated. Determination is made at block 504 of whether the position determination capability, e.g., GPS, is active in a standby operational mode. The standby mode may be set as a start up default or thereafter by user input. If it is determined at block 504 that position determination capability is not active, the process terminates. If position determination capability is active, as determined at block 504, determination is made at block 506 as to whether the linking application is active. The linking application may be launched in response to user action, e.g. key entry, or may occur automatically, such as by a default start up setting. If the linking application is not active, the process terminates.

If the linking application is active, as determined at block 506, determination is made at block 508 whether motion is sensed and, if so, whether the sensed motion matches a criterion for orientation change. This determination is made by the controller by comparing data represented by signals output by the motion sensor with the stored data characteristics of each stored data criterion. If no motion is sensed that matches a stored criterion, the process continues at block 508 until a motion is sensed. If motion is sensed that matches a criterion at block 508, the controller links the matched criterion to, and activates, the corresponding location database application at block 510. The linking, for example, may launch an application to activate position determination electronics, launch a position determination application, determine a position of the device and/or use the position in another application.

After activation at block 510, determination is made at block 512 whether the linking application is to be deactivated. Deactivation may responsive to a user input. If the link application is to remain active, as determined in block 512, the process reverts to block 508 to await further motion sensing; otherwise the process terminates.

In this disclosure there are shown and described only preferred embodiments and but a few examples of their versatility. It should be appreciated that the disclosure is not so limited but is applicable to various obvious modifications and equivalent arrangements, which fall within the purview of the appended claims. Although features of the claims are expressed in certain combinations, it is contemplated that these features can be arranged in any combination and order.

What is claimed is:

1. A method comprising:
defining a criterion of movement of a mobile communication device;
initiating movement of the mobile communication device by a user;
sensing motion of the device produced by the initiating step;
determining that the sensed motion meets a criterion defined in the defining step; and
in response to the step of determining, triggering activation of an application in the mobile communication device that is dependent on location of the device.

2. A method as recited in claim 1, wherein the step of defining comprises storing a data characteristic of the movement criterion; and the step of determining comprises matching a data characteristic of the sensed motion to the stored data characteristic.

3. A method as recited in claim 2, wherein the step of triggering comprises accessing a stored application associated with the matched data characteristic from a plurality of stored applications associated respectively with a plurality of stored data characteristics.

4. A method as recited in claim 1, wherein the predetermined criterion relates to a multi-directional change of position of the device.

5. A method as recited in claim 1, wherein the predetermined criterion relates to a change of orientation of the device.

6. A method as recited in claim 1, wherein the predetermined criterion comprises a predetermined orientation pattern change.

7. A method as recited in claim 1, wherein the triggering step comprises determining position of the communication device.

8. A method as recited in claim 7, further comprising:
updating a stored position of the device in the device memory, whereby the updated position is accessible by a remote recipient.

9. A method as recited in claim 1, wherein the triggering step comprises activating a navigation application stored in the communication device.

10. A method as recited in claim 9, wherein the step of activating comprises launching a search process for locating points of interest to the user that are in a geographic area of the device location.

10. A method as recited in claim 1, wherein the triggering step comprises transmitting a message that includes the device location to a remote recipient.

11. A mobile communication device comprising:
a controller;
a memory, wherein the memory is configured to store data defining a pattern of movement of the device and to associate a device application that is dependent on the location of the device with the defined pattern of movement; and
a motion sensor; wherein
the controller is configured to detect that user initiated movement sensed by the motion sensor matches the stored data and, in response to a match, to activate the application.

12. A mobile communication device as recited in claim 12, wherein the motion sensor is an accelerometer.

13. A mobile communication device as recited in claim 11, wherein the memory is configured to store data defining a plurality of device movement patterns, each of the patterns associated with a respective location dependent application, and the controller is responsive to the motion sensor to detect a match with one of the patterns and to activate an application that corresponds to the detected match.

14. A mobile communication device as recited in claim 11, wherein the pattern of movement relates to a multi-directional change of position of the device.

15. A mobile communication device as recited in claim 11, wherein the predetermined criterion relates to a change of orientation of the device.

16. A mobile communication device as recited in claim 11, wherein the application comprises updating stored device location in memory.

17. A mobile communication device as recited in claim 16, further comprising a communication interface, and the application further comprises transmitting a message that includes the device location to a remote recipient.

18. A mobile communication device as recited in claim 11, wherein the application comprises a user navigation functionality.

19. A mobile communication device as recited in claim 11, wherein the application comprises a user location based search functionality.

20. A mobile communication device as recited in claim 11, wherein the controller is configured to change operation of the device from a standby mode to an active mode in response to the match.
